(19) United States
(12) Patent Application Publication
(10) Pub. No.: US 2009/0236531 A1
(43) Pub. Date: Sep. 24, 2009

(54) HORIZONTAL SENSOR ARRAYS FOR NON-INVASIVE IDENTIFICATION OF HAZARDOUS MATERIALS

(75) Inventor: DAVID L. FRANK, Boca Raton, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Innovative American Technology, Inc., Coconut Creek, FL (US)

(21) Appl. No.: 12/409,758

(22) Filed: Mar. 24, 2009

Related U.S. Application Data
(60) Provisional application No. 61/070,560, filed on Mar. 24, 2008.
(60) Provisional application No. 61/128,115, filed on May 19, 2008.

(51) Int. Cl. G01T 1/20; G06K 9/00

(52) U.S. Cl. 250/362; 382/181; 250/361 R

(57) ABSTRACT

A system, method, and frame structure detect radiation and identify materials associated with radiation that has been detected. An entity to be examined is determined to have entered between a frame structure. A set of radiation data is received from a set of radiation sensors mechanically coupled to a portion of the frame structure. The set of radiation sensors includes multiple radiation sensors situated in a horizontal configuration with respect to each other and a direction of travel through the frame structure associated with the entity currently being examined. At least one histogram is generated based on the set of radiation data. The at least one histogram is compared to a plurality of spectral images associated with known materials. The at least one histogram is determined to substantially match at least one of the plurality of spectral images. Personnel are notified that the at least one radiation source is a hazardous material.

### CROSS-REFERENCE TO RELATED APPLICATIONS

This application is based on and claims priority to co-pending provisional U.S. Patent Application No. 61/070,560, entitled “Horizontal Sensor Arrays For Non-Invasive Analysis Of CBRNE Materials Present”, filed on Mar. 24, 2008, by the same inventor, and to co-pending provisional U.S. Patent Application No. 61/128,115, entitled “Mobile Frame Structure With Passive/Active Sensor Arrays For Non-Invasive Analysis For CBRNE Materials Present”, filed on May 19, 2008, by the same inventor, and to co-pending provisional U.S. Patent Application No. 61/XXX,XXX, entitled “Method For Increased Gamma/Neutron Detector Performance”, filed on Feb. 25, 2009, by the same inventor, and to co-pending provisional U.S. Patent Application No. 61/XXX,XXX, entitled “Method For Increased Gamma/Neutron Detector Performance, version 2”, filed on Mar. 13, 2009, by the same inventor, and to co-pending provisional U.S. Patent Application No. 61/XXX,XXX, entitled “High Performance Neutron Detector With Near Zero Gamma Cross Talk”, filed on Mar. 4, 2009, by the same inventor, and to co-pending provisional U.S. Patent Application No. 61/XXX,XXX, entitled “High Performance Neutron Detector With Near Zero Gamma Cross Talk, version 2”, filed on Mar. 13, 2009, by the same inventor; the entire collective teachings of which being incorporated herein by reference.

### FIELD OF THE INVENTION

The present invention generally relates to the field of hazardous material detection, and more particularly relates to radiation sensor arrays disposed for detecting and identifying hazardous materials.

### BACKGROUND OF THE INVENTION

Current radiation portals used in security applications for inspecting vehicles and cargo are generally positioned as vertical portals. These vertical portals utilize opposing pillars that operate as scanners and include a concentration of sensors between the sensor pillars. Therefore, the target to be analyzed has a moving geometry in relation to the sensors in the vertical sensor arrays deployed in the vertical pillars. This vertical configuration also results in the optimum detection position being held between the two opposing sensor pillars for a very short time as the object moves through the portal.

This vertical configuration is generally insufficient when radiation detection is a concern. This is because a vertical configuration usually does not provide the sensors with adequate time to acquire enough data to perform effective spectral analysis and hazardous material identification operations. For example, a vehicle traveling at 5 mph in front of the vertical sensor pillar only allows hazardous materials within the vehicle to be directly in front of the sensors for less than one second. Having the vehicle stop in front of the sensor pillar requires manipulation of the vehicle for enabling multiple test positions for addressing the entire container/vehicle. It also significantly slows down an operational process which detrimentally impacts productivity and efficiency.

Increasing vertically the number of sensors to expand the detector surface area and increase data acquisition results creates another set of problems. For example, each radiation sensor usually needs to be calibrated to ensure the accuracy of the spectral data provided. For multiple sensor arrays, each individual sensor needs to be calibrated and the array needs to have a synchronized calibration to combine the spectral data. As the number of detectors increases this process becomes more complex. The calibration for current radiation sensor technologies is modified with changes in temperature creating a moving calibration target. The use of a vertical sensor portal has proven to be difficult and does not allow for sufficient acquisition time.

Therefore a need exists to overcome these problems discussed above.

### SUMMARY OF THE INVENTION

In one embodiment, a method for detecting and identifying materials associated with radiation that has been detected is disclosed. The method comprises determining that an entity to be examined has entered between a first portion and at least a second portion of a frame structure. A set of radiation data associated with the entity is received from a set of radiation sensors mechanically coupled to the at least one portion of the frame structure. The set of radiation sensors includes multiple radiation sensors situated in a horizontal configuration with respect to each other and a direction of travel through the frame structure associated with the entity currently being examined. At least one histogram is generated based on the set of radiation data. The at least one histogram represents a spectral image associated with the entity. The at least one histogram is compared to a plurality of spectral images associated with known materials. The at least one histogram is determined to substantially match at least one of the plurality of spectral images. A determination is made as to whether the material associated with the at least one of the plurality of spectral images is a hazardous material. Personnel are notified that the at least one radiation source is a hazardous material in response to determining that the material associated with the at least one of the plurality of spectral images is associated with a hazardous material.

In another embodiment, a frame structure for detecting radiation and identifying materials associated with radiation that has been detected is disclosed. The frame structure includes at least one side portion and at least one set of radiation sensors. The at least one set of radiation sensors are mechanically coupled to the at least one side portion. The at least one set of radiation sensors include a plurality of radiation sensors situated in a horizontal configuration with respect to each other and a direction of travel provided through the frame structure to an entity being examined. A communication mechanism is communicatively coupled to the at least one set of radiation sensors. The communication mechanism transmits a set of radiation data associated with the entity that has been detected by the set of radiation detectors to at least one information processing system.

In yet another embodiment, a system for detecting radiation and identifying materials associated with radiation that has been detected is disclosed. The system includes a frame structure comprising at least one side portion. The frame structure also includes at least one set of radiation sensors. The at least one set of radiation sensors are mechanically coupled to the at least one side portion. The at least one set of radiation sensors includes a plurality of radiation sensors situated in a horizontal configuration with respect to each other and a direction of travel provided through the frame structure to an entity being examined. A communication mechanism is communicatively coupled to the at least one set of radiation sensors. The communication mechanism transmits a set of radiation data associated with the entity that has been detected by the set of radiation detectors to at least one information processing system. The system also includes at least one information processing system communicatively coupled to the at least one set of radiation sensors.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a general overview of an operating environment according to one embodiment of the present invention;

FIGS. 2-4 are block diagrams illustrating various examples of a frame structure according to embodiments of the present invention;

FIG. 5 is a block diagram illustrating a detection zone within the frame structure of FIG. 2 according to one embodiment of the present invention;

FIG. 6 is a block diagram illustrating multiple detection zones within the frame structure of FIGS. 2-4 according to one embodiment of the present invention;

FIG. 7 is a block diagram illustrating a more detailed view of one of the detection zones of FIG. 6 according to one embodiment of the present invention;

FIG. 8 is a block diagram illustrating one example of a sensor configuration within the frame structure of FIGS. 2-4 according to one embodiment of the present invention;

FIG. 9 is an operational flow diagram illustrating one process of detecting radiation and identifying hazardous materials associated with the radiation using a horizontal sensor array according to one embodiment of the present invention; and

FIG. 10 is a block diagram illustrating a detailed view of an information processing system suitable for use with an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

General Operating Environment

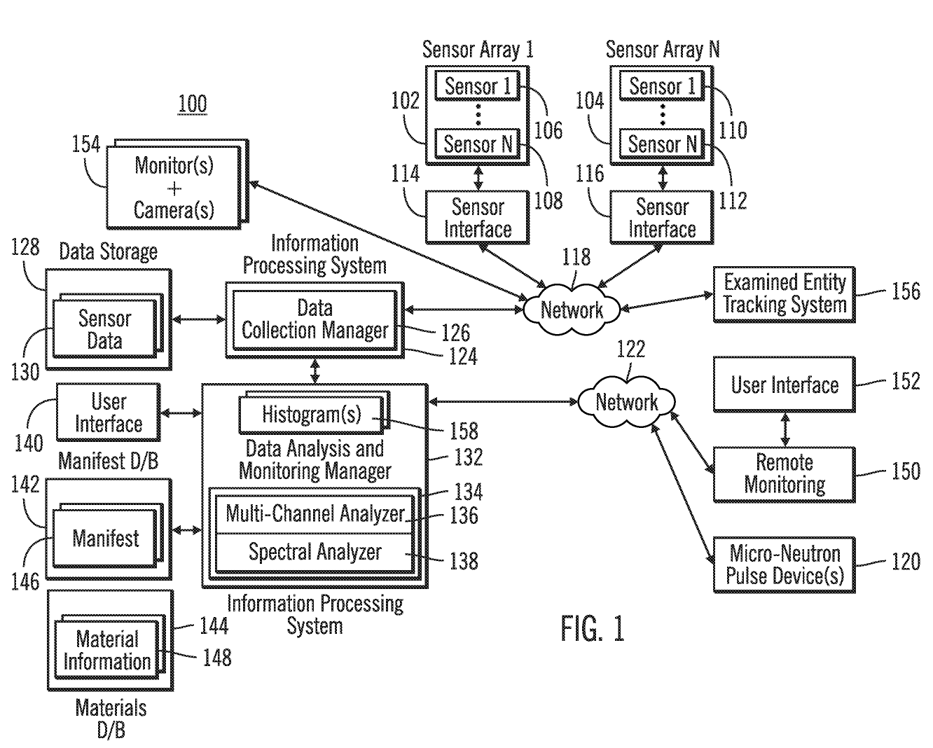

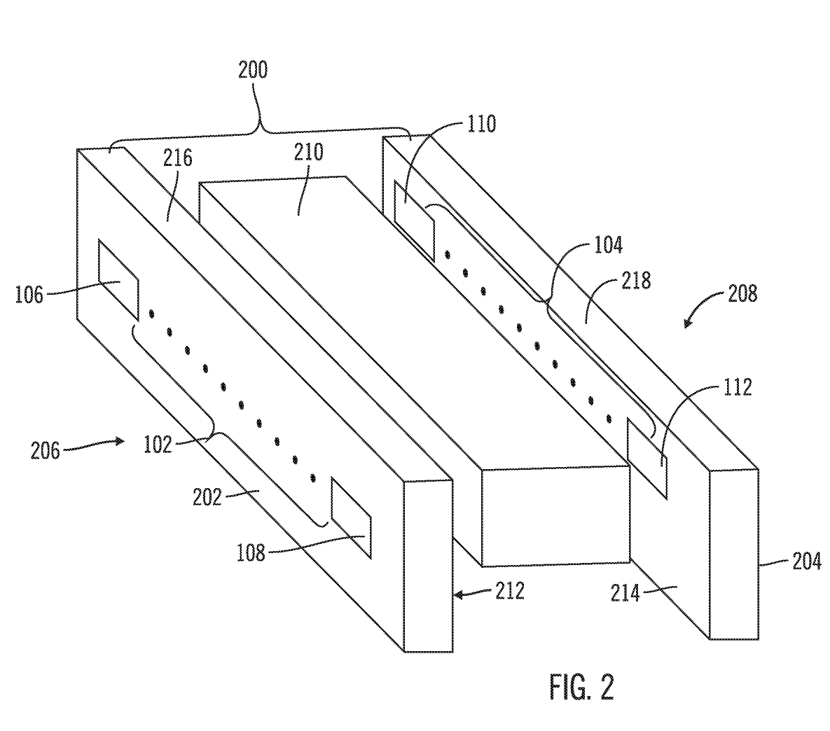

According to one embodiment of the present invention as shown in FIG. 1 a general view of an operating environment 100 is illustrated. In one embodiment all or part of the operating environment 100 is implemented with a frame structure 200 (FIG. 2) for enabling the detection, analysis, and identification of hazardous materials such as CBRNE materials. For example, a frame structure 200 can include horizontal side structures and/or one or more horizontal top structures that can be equipped with passive an/or active sensor systems for the non-invasive analysis of vehicles, trains, planes, boats, containers, packages, containers, and the like to detect and identify radiological, fissile, explosive, chemical, and biological materials.

In particular, FIG. 1 shows one or more sensor arrays 102, 104 each including a plurality of sensors 106, 108, 110, 112. One or more of these sensors, in one embodiment, are shielded from electro-magnetic-interference (“EMI”), but this is not required. In one embodiment, the sensors of one sensor array are gamma radiation sensor devices and the sensors in the other sensor array are neutron sensor devices. However, each of the sensor arrays 102, 104 can include a combination of gamma and neutron sensing devices as well. Examples of radiation detectors are cadmium zinc telluride detectors, sodium iodide detectors, and the like. Neutron detectors can be solid-state neutron detectors, which provide shock resistance. Also, to assist in the detection of radiation at distances, the gamma detectors may be equipped with collimators and/or lenses that gather the radiological particles and focus these particles onto the detectors. Shock resistance detectors are suitable for verifying radiation from objects that can move and cause shock/vibration hazards to the sensors. Each sensor array 102, 104 is communicatively coupled to a sensor interface 114, 116 either by a wired and/or wireless communication link. The sensor interfaces 114, 116 communicatively couple the sensor arrays 102, 104 to a first network 118 thereby creating a distributed sensor network.

The first network includes wired and/or wireless technologies and the sensor interface units 114 are communicatively coupled to the first network 118 either wirelessly and/or via wired mechanisms. In one embodiment, the sensor interfaces 114, 116 assign a unique IP address to each of the sensors 106, 108, 110, 112 within the sensor arrays 102, 104. The sensor interfaces 114, 116, in one embodiment, are sensor integration units (“SIU”) that provide the calibration, automated gain control, calibration verification, remote diagnostics, and connectivity to the processor for spectral analysis of the sensor data. SIUs are discussed in greater detail in in U.S. Pat. No. 7,269,527 entitled “System integration module for CBRNE sensors”, filed on Jan. 17, 2007, which is hereby incorporated by reference in its entirety. It should be noted that although FIG. 1 shows each of the sensor arrays 102, 104 coupled to a separate sensor interface 114, 116 a single sensor interface can be coupled to all of the sensor arrays 102, 104.

One or more micro-neutron pulse devices 120 are also optionally included within the operating environment 100 and are communicatively coupled to a second network 122. A micro-neutron pulse device 120 is an active analysis device that emits neutron pulses and whereby gamma feedback identifies shielded radiological materials such as highly enriched uranium, explosives, illicit drugs, or other materials. The first and second networks 118, 122 can include any number of local area networks and/or wide area networks. It should be noted that even though FIG. 1 shows two networks 118, 122, a single network can be implemented or additional networks can be added.

The operating environment 100 also includes an information processing system 124 communicatively coupled to the first network 110 via one or more wired and/or wireless communication links. The information processing system 124 includes a data collection manager 126 and is communicatively coupled to one or more data storage units 128. The one or more storage units 128 can reside within the information processing system 122 and/or outside of the system 122 as shown in FIG. 1. The data collection manager 126 manages the collection and/or retrieval of sensor data 130 generated by the sensors 106, 108, 110, 112 within the sensor arrays 102, 104 and optionally the micro-neutron pulse detector 120.

The data 130 generated by each of the sensors 106, 108, 110, 112, in one embodiment, is detailed spectral data from each sensor device that has detected radiation such as gamma radiation and/or neutron radiation. The data collection manager 126, in one embodiment, stores the data 130 received/retrieved from the sensor arrays 102, 104 and/or the neutron pulse detector 120 in one or more data storage devices 128. A data storage device 128 can be a single hard-drive, two or more coupled hard-drives, solid state memory devices, and/or optical media such as (but not limited to) compact discs and digital video discs, and the like. It should be noted that this list of storage devices is not exhaustive and any type of storage device can be used. It should also be noted that information processing system 124 including the data collection manager 126 is modular in design and can be used specifically for radiation detection and identification and/or for data collection for explosives and special materials detection and identification.

The operating environment 100, in one embodiment, also includes an information processing system 132 communicatively to the at least a second network 122 via one or more wireless and/or wired communication technologies. The information processing system 132, in one embodiment, includes a data analysis and monitoring manager 134 that analyzes and monitors the data 130 retrieved/received from the sensor arrays 102, 104 and optionally the micro-neutron pulse detector 120. The data analysis and monitoring manager 134, in one embodiment, includes a multi-channel analyzer 136 and a spectral analyzer 138. The data analysis and monitoring manager 134 and each of these components 136, 138 are discussed in greater detail below.

In one embodiment, a user interface 140, a manifest database 142, and a materials database 144 are communicatively coupled to the information processing system 132 either directly or via a network (e.g. the second network 122). The user interface 140, in one embodiment, includes one or more displays, input devices, output devices and/or the like, that allows a user to monitor and/or interact with the information processing system 132. The data and analysis functionality of the information processing system 132, which is discussed in greater detail below, can either be automated and/or supplemented with human interaction. The user interface(s) 140 enables this human interaction.

The manifest database 142 includes a plurality of manifests 146 associated with shipping cargo, which can be cargo on a water vessel, a ground vessel (e.g., cars, trucks, and/or trains), and/or an air transportation vessel. A manifest 146 includes a detailed description of the contents of each container or cargo that is to be examined by the sensor arrays 102, 104 and/or the neutron pulse device(s) 120. The manifests 146 are used by the information processing system 132 to determine whether the possible materials, goods, and/or products within the container package, car, truck, or the like match the expected authorized materials, goods, and/or products, described in the manifest 146 for the particular entity under examination. The use of a manifest 146 during examination of an entity is discussed in greater detail below.

The materials database 144 includes materials information 148 such as chemical material information, biological material information, radioactive material information, nuclear material information, and/or explosive material information. Also, the materials information 148 can include isotope information for known isotopes. For example, isotope information can include spectral images, histograms, energy levels, and/or the like associated with known isotopes. The materials information 148, in one embodiment, is used by the data analysis and monitoring manager 134 to determine whether any hazardous materials are within an entity that is being examined. This identification/detection process is discussed in greater detail below.

It should be noted that although the manifest database 142 and the materials database 144 are shown in FIG. 1 as being separate from the information processing system 132, one or more of these databases 142, 144 can reside within the information processing system 132 as well. Furthermore, the components of the information processing system 124 and the information processing system 132 can be implemented within a single information processing system as compared to multiple systems as shown in FIG. 1.

The operating environment 100, in one embodiment, also includes a remote monitoring information processing system 150 communicatively coupled to the second network 122. A user interface 152, which can be one or more displays, input devices, output devices and/or the like that allows a user to monitor and/or interact with the remote system 150 is communicatively to the system 150. The remote monitoring system 150 includes a computer, memory, and storage and enables a user to remotely monitor, manage, and/or control the frame structure 200 and/or the data analysis and monitoring processes being performed at the information processing system 132. Also, the remote monitoring system 150 can be a device such as a wireless communication device, portable computer, desktop and/or the like that receives notifications from the information processing system 132 regarding the data analysis and monitoring process.

In one embodiment, one or more monitors/camera systems 154 such as (but not limited to) a closed circuit television system is also included within the operating environment 100. The cameras within this system 154 can be deployed around a frame structure 200 at various locations so that an operator can monitor the entity being examined. Also, an examined entity tracking system 156 is also included within the operating environment 100. The examiner entity tracking system 156 tracks and monitors the identity of each entity such as a truck, car, train, boat, plain, cargo container, package, and the like being examined. The tracking system 156 can include digital cameras, radio frequency identification tag (“RFID”) readers, bar code scanners, character recognition mechanisms, marking systems, and the like that allow the tracking system to identify an entity currently being examined. This allows the information processing system 132 and/or an operator to determine if an entity has previously been examined and to also flag an entity when hazardous materials potentially reside within the entity.

Horizontal Sensor Arrays for Non-Invasive Detection of Hazardous Materials

The following is a more detailed discussion on implementing the operating environment 100 (or at least a portion of the environment) discussed above with respect to FIG. 1 on a frame structure 200. FIG. 2 shows one example of a frame structure 200 according to one embodiment of the present invention. The frame structure 200, in one embodiment, is a stationary portal that trucks, automobiles, cargo transporters, vehicles (e.g., vehicles that transport cargo or containers), forklifts, and any other motorized device that can carry or include objects to be examined, can pass through/under/over for analysis. It should be noted that the various embodiments of the present invention are not limited to analyzing vehicles. For example, carrier systems such as conveyor systems can also be configured to pass through/under/over the frame structure 200. Also, the frame structure of FIG. 2 can be utilized in a variety of different detection system such as shipping container inspection, seaport security, cargo terminal security, airport vehicle inspection, airport cargo inspection, airport baggage inspection, vehicle inspection, truck stop cargo inspection, border protection inspecting vehicles, cargo, persons, railway inspections, railcar inspection, subway security, and the like.

The frame structure 200, in one embodiment, includes at least one side member 202, 204 on each side 206, 208 of the structure 200. The side members 202, 204 are situated parallel to each other on opposing sides 206, 208 of the structure 200. An entity/object 210 such as a car, truck, boat, plane, luggage, packages, motorcycle, train, cargo containers, semi-trailers, and the like are able to pass substantially between the side members 202, 204. The side member 202 situated at the first side 206 of the structure 200 comprises one or more sensor arrays 102. The side member 204 situated at the second side 208 of the structure 200 also comprises one or more sensor arrays 104. As discussed above, the sensor arrays 102, 104 include a plurality of sensors 106, 108, 110, 112, respectively.

FIG. 2 shows that the sensors 106, 108 within the sensor array(s) 102 deployed on the first side member 202 are situated in a horizontal configuration with respect to a y-axis direction. In other words, the sensors 106, 108 are situated adjacent to each other and are parallel to a direction of travel of an entity 210 substantially through the structure 200. or along the length of the entity 210 to be examined. The sensors 110, 112 within the sensor array(s) 104 deployed on the second side member 204 are situated in a substantially similar configuration as the sensors 106, 108 within the first side sensor array 102. Therefore, the sensors 106, 108, 110, 112 are deployed on both sides of a detection area of the frame structure 200 and in multiple positions on each side to provide adequate coverage of the full length of an entity 210 being examined. The sensors can be configured as a one or more horizontal arrays positioned along the centerline of the entity 210 to minimize the number of sensors required and to optimize the data acquisition times.

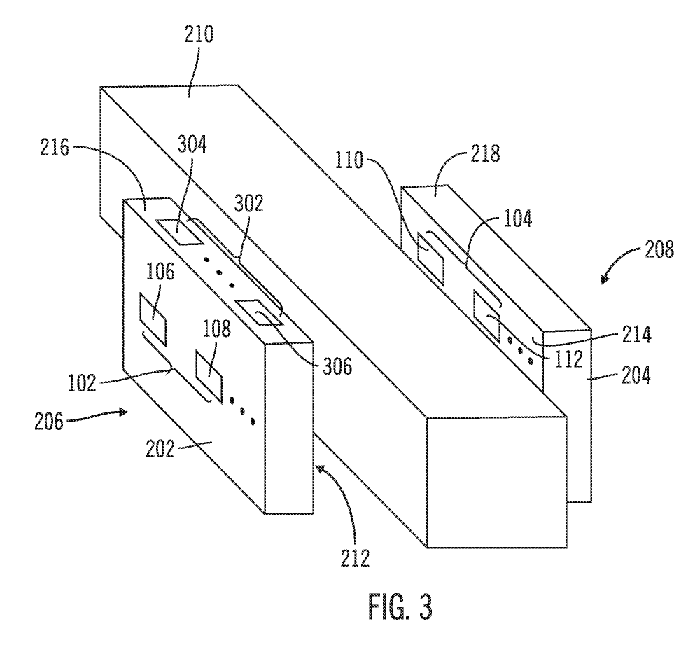

In one embodiment, one of the horizontal sensor arrays 102, 104 includes gamma sensors while the other horizontal sensor array 102, 104 includes neutron sensors. However, each horizontal array can include a combination of both sensor types and/or neutron pulse devices as well. In one embodiment, the sensors 106, 108, 110, 112 within each horizontal sensor array 102, 104 are disposed on an inner wall 212, 214 of each side member 202, 204. However, each horizontal sensor arrays 102, 104 can also be disposed on an upper portion 216, 218 of the side members 202, 204 as well in a similar horizontal configuration. Also, the horizontal sensor arrays 102, 104 can be disposed on the inner walls 212, 214 as shown in FIG. 2 and additional sensor arrays 302 including a plurality of sensors 304, 306 can be disposed on upper portions 216, 218 of at least one of the side members 202, 204 as shown in FIG. 3.

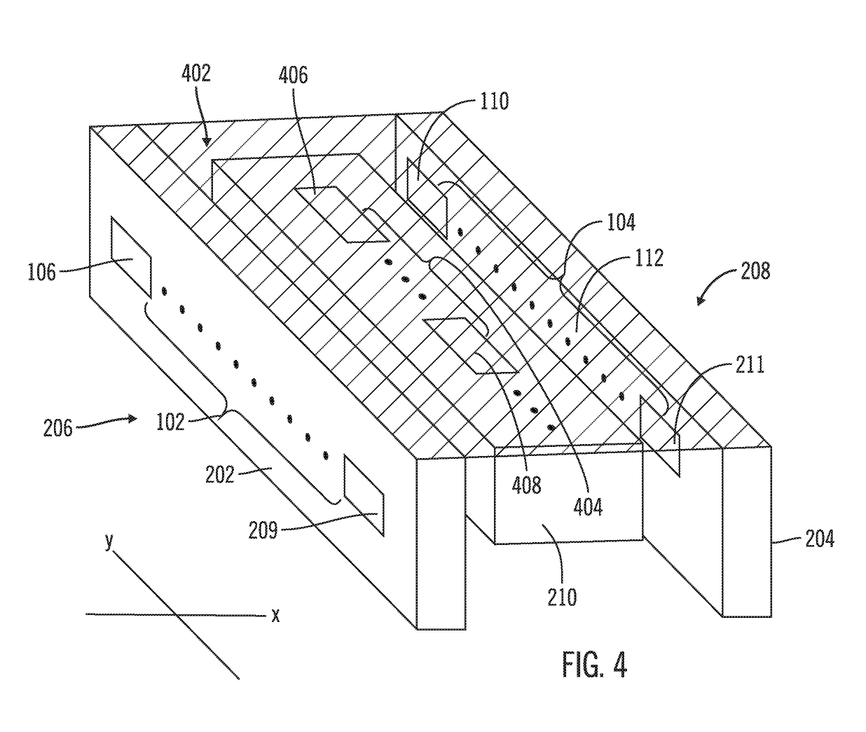

It should be noted that the length, width, and height of the side members 202, 204 as shown in FIG. 1 are only illustrative and do not limit the present invention in any way. For example, the side members 202, 204 can be shorter in length as shown in FIG. 3 or longer in length. Also, a top portion 402 can also be included on the frame structure 200 as shown in FIG. 4. The top portion 402 is situated on the top portion 216 of the first side member 202 and extends over to and is situated on the top portion 218 of the second side member 204. The top portion 402 is shown as “see-through” in FIG. 4 for illustration purposes only.

The top portion 402 of the frame structure 200, in one embodiment, also includes one or more horizontal sensor arrays 404 that comprise a plurality of sensors 406, 408. The sensors can be either gamma sensors and/or neutron sensors. Furthermore, instead of sensors or in addition to the sensors one or more micro-neuron pulse devices (not shown) can be disposed on the top portion 402 as well. The sensors 406, 408 within the top portion sensor array(s) 404 are also situated in a horizontal configuration similar to the arrays 102, 104 discussed above with respect to FIG. 2. In other words, the sensors 406, 408 are situated horizontally in a direction that is parallel to a direction of travel of an entity 210 to be examined through the frame structure 200. Although not shown, the frame structure 200 can include a bottom portion that is situated underneath an entity 210 to be examined. One or more sensor arrays and/or micro-neutron pulse devices can be disposed thereon in a similar horizontal configuration.

The horizontal sensor arrays 102, 104, 120 can be configured to meet a wide variety of applications such as: shipping container inspection, seaport security, cargo terminal security, airport vehicle inspection, airport cargo inspection, airport baggage inspection, vehicle inspection, truck stop cargo inspection, border protection inspecting vehicles, cargo, persons, railway inspections, railcar inspection, subway security, persons, and more.

The horizontal configuration of the sensor arrays as shown in FIGS. 2-4 is advantageous because greater scan times are yielded, which allows more time for spectral analysis and identification of hazardous material such as chemical, biological, radioactive, fissile, nuclear, and explosive material identification with respect to an object 210 being examined. The distributed array of sensors disposed in the horizontal arrays 102, 104 enables an entity 210 to be examined to either briefly stop for examination or continue to pass through the frame structure 200 during the examination operation.

Therefore, the frame structure 200 with the horizontal sensor arrays 102, 104 enables the operating environment 100 to scan the contents of an entity 210 as the entity 210 enters and exits the frame structure 200; (2) provides a fixed geometry between the sensor arrays 102, 104 and the target materials when entity 210 is stopped; (3) provides an ability to analyze the entity 210 within seconds from a single position; and (4) perform adequate spectral data acquisition within seconds, thereby enabling identification of the hazardous materials within the entity 210 (discussed in greater detail below).

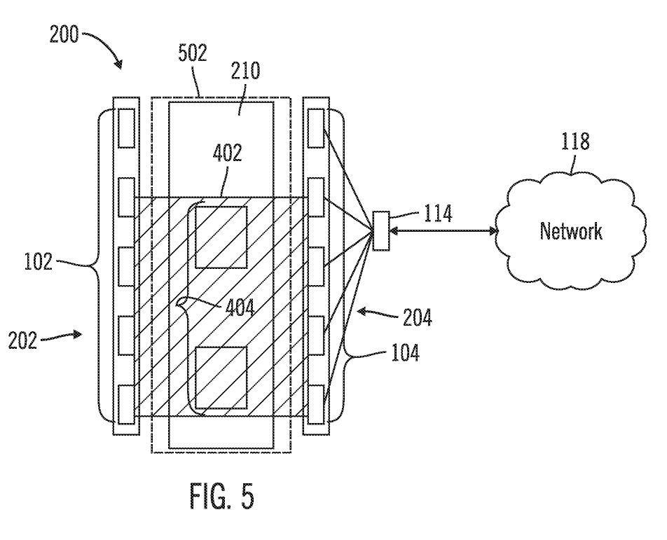

The frame structure 200 includes a detection area/zone 502 (see FIG. 5) which is the area in front of or between the horizontal detector arrays 102, 104 (and 302, 404 if included). For example, FIG. 5 shows a detection zone 502 existing between a distributed sensor array comprising a horizontal sensor array 102 deployed on a first side 202 of the frame structure 200, a horizontal sensor array 104 deployed on a second side 204 of the frame structure 200, and a horizontal sensor array 404 deployed on an optional area/portion 402 of the frame structure 200 that is above (and/or below) the entity 210 being examined. Each of the horizontal sensor arrays 102, 104, 404 is communicatively coupled to one or more SIUs 114, which is communicatively coupled to one or more networks 118.

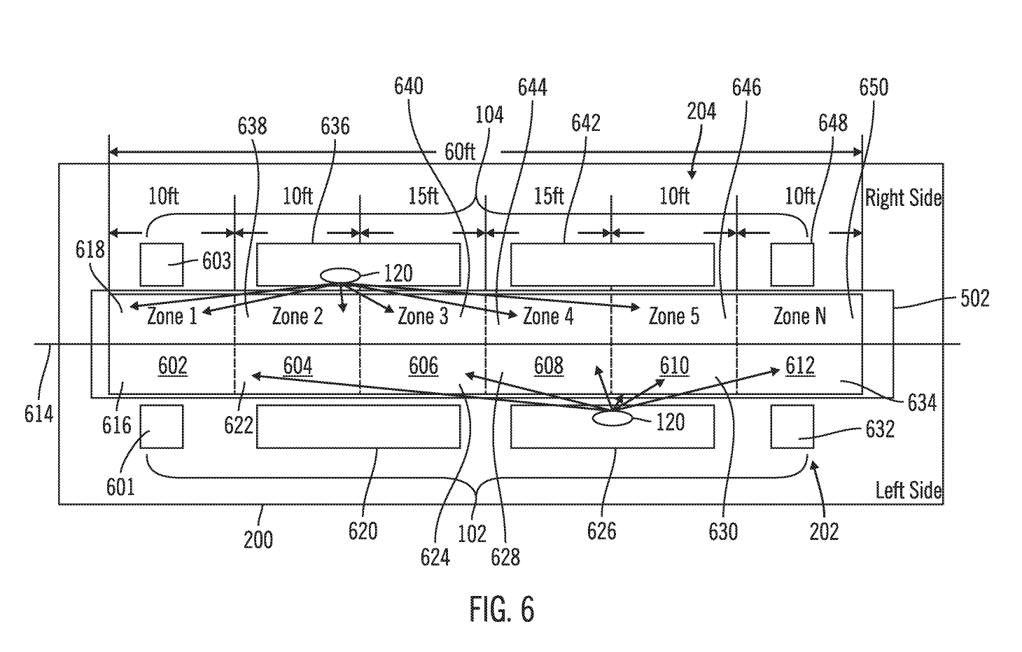

The detection zone 502, in one embodiment, is partitioned into a plurality of different zones, each zone being associated with one or more sensors in a horizontal sensor array 102, 104, 404. For example, FIG. 6 shows a top view of a plurality of zones 602, 604, 606, 608, 610, 612 within a frame structure 200 that comprises a target detection area 502. A first horizontal sensor array 102 is deployed on a first side 202 of the frame structure 200 and a second horizontal sensor array 104 is deployed on a second side 204 of the frame structure 200 opposite from the first side 202. FIG. 6 also shows an imaginary center line 614 running the length of the zones. This imaginary center line 614 is shown for reference purposes only to denote a first portion 616 (e.g., a left portion) of a zone and a second portion 618 (e.g., right portion) of a zone.

Each portion 616, 618 of a zone 602 is associated with one or more sensors 601, 603 of the sensor array 102, 104 deployed on that particular side 202, 204 of the frame structure 200. For example, the horizontal sensor array 102 deployed on the first side 202 of the frame structure 200 (which is the left side in this example) has a first set 601 of sensors associated with a first portion 616 (which is the portion to the left of the centerline 614 in this example) of Zone_1 602. The horizontal sensor array 104 deployed on the second side 204 of the frame structure 200 (which is the right side in this example) has a set of sensors 603 associated with a second portion 618 (which is the portion to the right of the centerline 614 in this example) of Zone_1 602.

FIG. 6 also shows that a second set 608 of sensors in the first horizontal array 102 is associated with a first portion 622 of Zone_2 604 and a first portion 624 of Zone_3 606. A third set 626 of sensors in the first horizontal array 102 is associated with a first portion 628 of Zone_4 608 and a first portion 620 of Zone_5 610. A fourth set of sensors 632 in the first horizontal array 102 is associated with a first portion 634 of a Zone_N 612. FIG. 6 further shows that a second set 636 of sensors in the second horizontal array 104 is associated with a second portion 638 of Zone_2 604 and a second portion 640 of Zone_3 606. A third set of sensors 642 in the second horizontal array 104 is associated with a second portion 644 of Zone_4 608 and a second portion 646 of Zone_5 610. A fourth set of sensors 648 in the second horizontal array 104 is associated with a second portion 650 of Zone_N 612.

It should be noted the sensors are not limited to only scanning their associated zone portion as the sensors can be configured to scan across both portions 616, 618 of a zone. For example, sensors within the first set 601 of the first horizontal array 102 can scan from the “left” side 616 of Zone_1 602 across to the “right” side 628 of Zone_1 602. Sensors within the first set 603 of the second horizontal array 104 can scan from the “ride” side 618 of Zone_1 602 across to the “left” side 626 of Zone_1 602. This results in scans with different perspectives.

However, in one embodiment, sensors are configured to scan out to given distances and in given directions. Therefore, the zones are partitioned according to the sensor types being deployed in the sensor arrays and based on sensor configurations (e.g., known distances and directions associated with each sensor within an array). For example, FIG. 6 shows that each zone with the exception of Zone_3 606 and Zone_4 608 (spaced 15 ft apart from adjacent zones) are spaced 10 ft apart. It should be noted that these distances are only examples and do not limit the present invention in any way. The number of zones and the spacing of zones, in one embodiment, is a function of the sensor configurations within the sensor arrays.

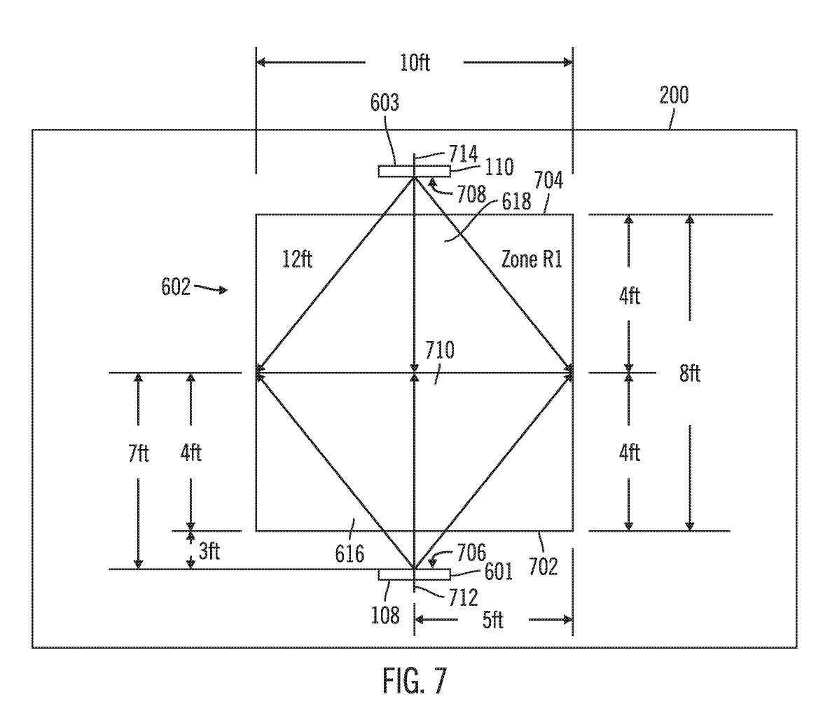

FIG. 7 shows a more detailed view of Zone_1 602. In particular, FIG. 7 shows scanning distances and directions associated with sensors in a set of sensors for each portion of the zone. For example, FIG. 7 shows a first sensor 601 within the first side horizontal sensor array 102 associated with Zone_1 602 and a second sensor 603 within the second side horizontal sensor array 104 associated with Zone_1 602. FIG. 7 also shows that Zone_1 602 is 8 ft wide with each portion 616, 618 of the zone being 4 ft wide. Each sensor 601, 603 is situated on the frame structure 200 3 ft from an outer edge 702, 704 of the zone. Therefore, a portion 706, 708 of the sensor 601, 603 facing the outer edge 702, 704 of the zone is 7 ft from an inner edge 710 (e.g., the center line) of the zone. The sensors 601, 603 are also deployed on the frame structure 200 such that a middle line 712, 714 of the sensors is substantially aligned with the midpoint of the zone. Each sensor 601, 603 also scans out in all directions to the inner edge 710 (centerline) of its portion 616, 618, as shown in FIG. 7. It should be noted that distances and configurations shown in FIG. 7 are for illustrative purposes only and do not limit the present invention in any way.

Returning back to FIG. 6, FIG. 6 also shows placements of micro-pulse neutron devices 120. In particular, FIG. 6 shows that one or more micro-neutron pulse devices 120 are deployed within the third set 626 of sensor of the first side horizontal sensor array 102 and the second set 636 of sensors in the second side horizontal sensor array 104. As can be seen, this deployment configuration allows each of the zones 602, 604, 606, 608, 610, 612 to be associated with at least one micro-neutron pulse device 120. It should be noted that the micro-neutron pulse devices 120 are not limited to being deployed on the sides 202, 204 of the frame structure 200. For example, one or more micro-neutron pulse devices 120 can be deployed above/below the sensor arrays 102, 104 and the entity 210 being examined. In this embodiment, the neutron pulse devices 120 can be deployed above the sensor arrays 102, 104 and the entity 210 on the side members 202, 204 of the structure 200 or directly above the entity 210. The neutron device 120 can also be deployed under the sensor arrays 120, 104 and/or under the entity 210 as well. It should be noted that the deployment configuration of the micro-neutron pulse devices 120 shown in FIG. 6 is only for illustration purposes and does not limit the present invention in any way.

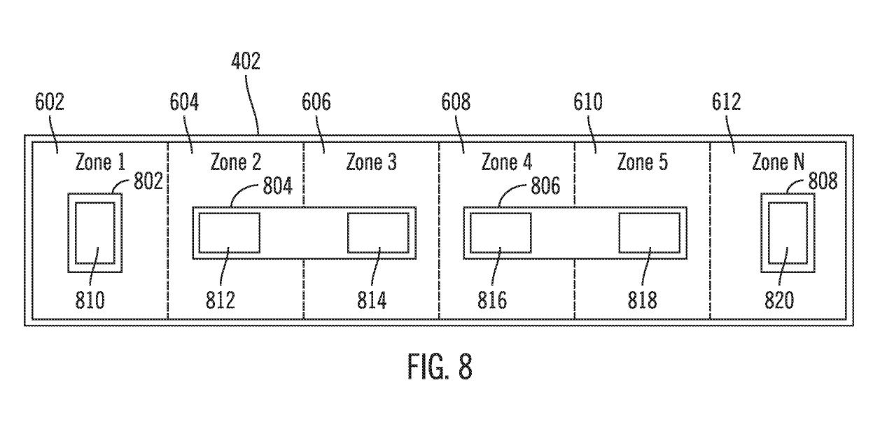

FIG. 8 shows additional deployment configurations for gamma and neutron sensors. For example, FIG. 8 shows sensor sets 802, 804, 806, 808 comprising sensors 810, 812, 814, 816, 818, 820 such as gamma and/or neutron sensors being deployed on a top portion 402 of the frame structure 200. As discussed above, the top portion 402 of the frame structure 200 is situated above the entity 210 being examined. In the example of FIG. 8 one or more sensors 810, 812, 814, 816, 818, 820 are deployed over each zone 602, 604, 606, 608, 610, 612. In particular, a first sensor set 802 comprising sensor 810 is associated with Zone_1 602, a second sensor set 804 comprising sensor 812 associated with Zone_2 604 and sensor 814 associated with Zone_2 606, a third sensor set 806 comprising sensor 612 associated with Zone_4 608 and sensor 818 associated with Zone_5 610, and a fourth sensor set 808 comprising sensor 820 associate with Zone_N 612.

In one embodiment, the first and fourth sensor sets 802, 820 are situated parallel to each other and perpendicular to the second and third sensor sets 804, 806. The configuration of FIG. 8 is also applicable to a deployment configuration of sensors underneath an entity to be examined as well. Also, neutron pulse devices 120 can also be deployed in a similar fashion. It should be noted that the deployment configuration of FIG. 8 is used for illustrative purposes only and the sensors can be deployed in other configurations as well.

With respect to examining an entity 210 to identify hazardous materials, the entity 200 moves or is moved between the side members 202, 204 of the frame structure 200. In this embodiment, the frame structure 200 and the entity 210 can be stationary with respect to each other. In another embodiment, the entity 210 can drive/move in between the two side members 202, 204 and continue to move or be moved through the frame structure as the scanning, analysis, and identification operations are performed.

As the sensor arrays 102, 104 scan the entity 210, each of the gamma and/or neutrons sensors generate signals indicative of any gamma and/or neutron radiation detected. As discussed above, this sensor data 130 is collected by the data collection manager 126 and stored within one or more data storage units 128. The data analysis and monitoring manager 134 then analyzes the data 130 to determine if any hazardous materials have been detected.

For example, the data analysis and monitoring manager 134 includes a multi-channel analyzer (“MCA”) 136 comprising one or more devices a device composed of multiple single channel analyzers (“SCA”). In one embodiment, the MCA 136, uses analog to digital converters combined with computer memory that is equivalent to thousands of SCAs and counters and is dramatically more powerful and cost efficient than individual SCAs. The SCA interrogates analog signals received from the individual radiation detectors 106, 108, 110, 112, and determines whether the specific energy range of the received signal is equal to the range identified by the single channel. If the energy received is within the SCA an SCA counter is updated. Over time, the SCA counts are accumulated. At a given time interval, a multi-channel analyzer 136 includes a number of SCA counts, which result in the creation of a histogram 158.

The histogram 158 represents the spectral image of the radiation that is present within the entity being examined. In other words, the histogram 170 is a fingerprint of the entity being examined. The histogram 170 can represent a portion of the entity or the entire entity. In one embodiment, a single histogram 158 can be created based on information received from all of the sensor arrays 102, 104. In another embodiment, a single histogram 158 can be created from the combination of one or more histograms associated with one or more sensors 106, 108, 110, 112 in the sensor arrays 102, 104. In yet another embodiment, a histogram 158 can be created for each sensor 106, 108, 110, 112 within the sensor arrays 102, 104. A more detailed discussion on histograms is given in U.S. Pat. No. 7,142,109 entitled “Container Verification System For Non-Invasive Detection Of Contents”, filed on Feb. 27, 2006; and U.S. Pre-Grant Publication 2008/0048872 entitled, “Multi-Stage System For Verification Of Container Contents”, filed on Oct. 31, 2007, which are both commonly owned and hereby incorporated by reference in their entireties.

The histogram 158 is used by the spectral analyzer 138 to identify isotopes that are present in materials residing within in the entity under examination. One of the functions performed by the data and analysis manager 134 is spectral analysis, performed by the spectral analyzer 138, to identify the one or more isotopes, explosives or special materials residing within the entity under examination. With respect to radiation detection, the spectral analyzer 138 compares one or more spectral images (e.g., represented by histograms 158, and/or by other collections of data associated with the sensors) of the radiation that has been detected within the entity 210 to known isotopes that are represented by one or more spectral images stored 148 in the materials database 144. By capturing multiple variations of spectral data for each isotope there are numerous images that can be compared to one or more spectral images of the radiation present.

The materials database 144 holds material information 148 such as one or more spectral images 148 of each isotope to be identified. These multiple spectral images represent various levels of acquisition of spectral radiation data so isotopes can be compared and identified using various amounts of spectral data available from the one or more sensors. Whether there are small amounts or large amounts of data acquired from the sensor, the spectral analyzer 138 compares the acquired radiation data from the sensor 106, 108. 110, 112 to one or more spectral images 148 for each isotope to be identified. This significantly enhances the reliability and efficiency of matching acquired spectral image data from the sensor to spectral image data of each possible isotope to be identified.

Once one or more possible isotopes are determined to be present in the radiation detected by the sensor(s) 106, 108, 110, 112, the data analysis and monitoring manager 134 compares the isotope mix against possible materials, goods, and/or products that may be present in the entity 210 under examination. The manifest database 142 includes a detailed description 146 of the contents of each entity 210 that is to be examined. The manifest 146 can be referred to by the data analysis and monitoring manager 134 to determine whether the possible materials, goods, and/or products, contained in the entity 210 match the expected authorized materials, goods, and/or products, described in the manifest 146 for the particular container under examination. This matching process, according to one embodiment of the present invention, is significantly more efficient and reliable than any container contents monitoring process in the past.

It should be noted that the spectral analyzer 138 is able to utilize various methods to provide multi-confirmation of the isotopes identified. Should more than one isotope be present, the spectral analyzer 138 identifies the ratio of each isotope present. Examples of methods that can be used for spectral analysis such as that discussed above include: 1) a margin setting method as described in U.S. Pat. No. 6,847,731 entitled “Method And System For Improving Pattern Recognition System Performance”, filed on Aug. 7, 2000, which is hereby incorporated by reference in its entirety; and 2) a LINSCAN method (a linear analysis of spectra method) as described in U.S. Provisional patent application Ser. No. 11/624,067, filed on Jan. 17, 2006, by inventor David L. Frank, and entitled “Method For Determination Of Constituents Present From Radiation Spectra And, If Available, Neutron And Alpha Occurrences”; the collective entire teachings of which being herein incorporated by reference.

With respect to analysis of collected data pertaining to explosives and/or special materials, the spectral analyzer 138 and compares identified possible explosives and/or special materials to the manifest 148 by converting the stored manifest data 148 relating to the entity 210 under examination to expected explosives and/or radiological materials and then by comparing the identified possible explosives and/or special materials with the expected explosives and/or radiological materials. If the system 134 determines that there is no match to the manifest 148 for the entity 210 then the identified possible explosives and/or special materials are unauthorized. The system 134 can then provide information to system supervisory personnel to alert them to the alarm condition and to take appropriate action. For example, the user interface 140, 152 can present to a user a representation of the collected received returning signals, or the identified possible explosives and/or special materials in the entity 210 under examination, or any system identified unauthorized explosives and/or special materials contained within the entity 210 under examination, or any combination thereof.

A more detailed discussion on spectral analysis is given in U.S. Pat. No. 7,142,109 entitled “Container Verification System for Non-Invasive Detection of Contents”, filed on Feb. 27, 2006; and U.S. Pre-Grant Publication 2008/0048872 entitled, “Multi-Stage System For Verification Of Container Contents”, filed on Oct. 31, 2007, which are collectively commonly owned and hereby incorporated by reference in their entirety.

In addition to gamma and neutron sensors, neutron pulse devices 120 can also be deployed on the frame structure 200 as discussed above. The neutron pulse devices 120 include coincident counting capabilities. The gamma detectors within the neutron pulse device are used to identify chemical and explosives materials from the gamma response to the neutron pulse. The neutron detectors are used to identify shielded nuclear materials from the response.

The micro-neutron pulse device(s) 120 creates an active detection system that is deployed on the frame structure 200 that enable the identification of chemical, nuclear and explosives materials based on the response from the neutron pulse. These non-intrusive inspection systems can interrogate entities 210 for the detection of shielded nuclear materials while maintaining a high hourly throughput in ports of entry, ports of departure, borders and other checkpoints. A more detailed discussion on using micro-neutron pulse devices is given in the co-pending provisional U.S. Patent Application No. 61/128,115, entitled “Mobile Frame Structure With Passive/Active Sensor Arrays For Non-Invasive Analysis For CBRNE Materials Present”, filed on May 19, 2008, by the same inventor of the present application, and which is hereby incorporated by reference in its entirety.

The various embodiments discussed above are advantageous because the horizontal sensor array configurations yield greater scan times, which allows for spectral analysis and hazardous material identification with respect to an object being examined. Therefore, the frame structure comprising the horizontal sensor arrays discussed above enables the scanning of the entity as the entity enters and exits the frame structure; (2) provides a fixed geometry between the horizontal sensor arrays and the target materials when an entity is stopped; (3) provides an ability to analyze the entity within seconds from a single position; and (4) performs adequate spectral data acquisition within seconds, thereby enabling identification of the hazardous materials within the entity.

Example of a Process for Radiation Detection and Identification Using a Horizontal Sensor Array(s)

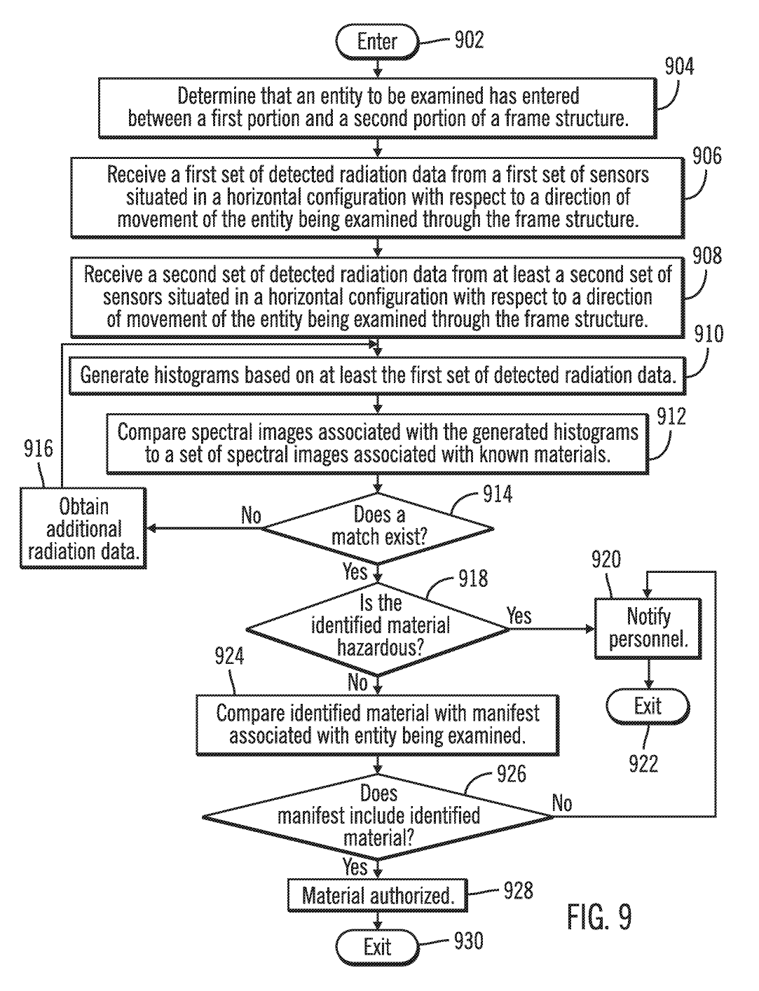

FIG. 9 is an operational flow diagram illustrating one process of detecting radiation and identifying hazardous materials associated with the radiation using a horizontal sensor array. The operational flow diagram starts at step 902 and flows directly into step 904. The data analysis and monitoring manager 134, at step 904, determines that an entity 210 to be examined has entered between a first portion 202 and a second portion 204 of a frame structure 200. The manager 134, at step 906, receives a first set of detected radiation data from a first set of sensors 102 that are situated in a horizontal configuration with respect to a direction of movement of the entity being examined through the frame structure 200. The manager 134, at step 908, receives a second set of detected radiation data from at least a second set of sensors 104 that are situated in a horizontal configuration with respect to a direction of movement of the entity being examined through the frame structure 200. For example, the manager 134 can receive gamma and/or neutron counts, and associated with an energy level detected by the sensor arrays 102, 104. It should be noted that neutron pulse information can also be provided to the manager 134 as well. It should be noted that the sensor arrays 102, 104 can perform their detection operations while the entity 210 is moving through the frame structure 200 and/or is stationary with respect to the frame structure 200.

The manager 134, at step 910, generates one or more histograms 148 based on at least the first set of detected radiation data. The manager 134, at step 912, compares spectral images associated with the generated histograms to a set of spectral images 148 associated with known materials. The manager 134, at step 914, determines if a match exists between the spectral images associated with the generated histograms 148 and the set of spectral images 148 associated with known materials. If the result of this comparison is negative, the manager 134, at step 916, obtains additional radiation data from the sensors 102, 104 and the control flow returns to step 910. If the result of this determination is positive, the manager 134, at step 918, determines if the material identified by the comparison is hazardous. If the result of this determination is positive, the manager 134, at step 920, notifies personnel. The control flow then exits at step 922.

If the result of this determination is negative, the manager 134, at step 924, compares the identified material with a manifest 146 associated with the entity being examined. The manager 134, at step 926, determines if the manifest includes the identified material. If the result of this determination is negative, the identified material is unauthorized and the manager 134, at step 920, notifies personnel. The control flow then exits at step 922. If the result of this determination is positive, the manager 134, at step 928, determines that the identified material is authorized and the control flow then exits at step 930.

Information Processing System

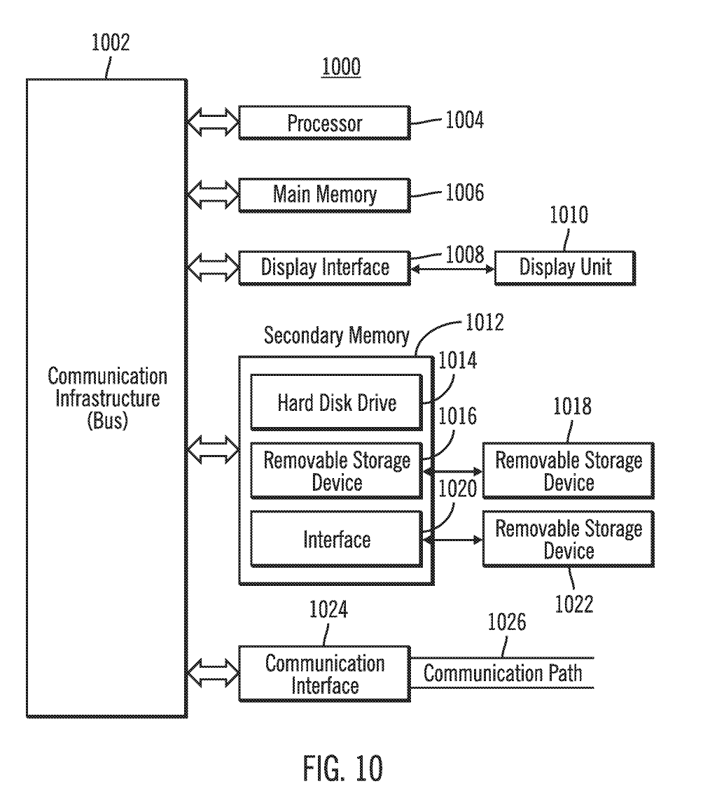

FIG. 10 is a high level block diagram illustrating a more detailed view of a computing system 1000 such as the information processing system 132 suitable for implementing the data and analysis manager 134 according to various embodiments of the present invention. The computing system 1000 is based upon a suitably configured processing system adapted to implement an embodiment of the present invention. For example, a personal computer, workstation, or the like, may be used.

In one embodiment of the present invention, the computing system 1000 includes one or more processors, such as processor 1004. The processor 1004 is connected to a communication infrastructure 1002 (e.g., a communications bus, crossover bar, or network). Various software embodiments are described in terms of this example of a computer system. After reading this description, it should become apparent to a person of ordinary skill in the relevant art(s) how to implement an embodiment of the invention using other computer systems and/or computer architectures.

The computing system 1000 can include a display interface 1008 that forwards graphics, text, and other data from the communication infrastructure 1002 (or from a frame buffer) for display on the display unit 1010. The computing system 1000 also includes a main memory 1006, preferably random access memory (RAM), and may also include a secondary memory 1012 as well as various caches and auxiliary memory as are normally found in computer systems. The secondary memory 1012 may include, for example, a hard disk drive 1014 and/or a removable storage drive 1016, representing a floppy disk drive, a magnetic tape drive, an optical disk drive, and the like. The removable storage drive 1016 reads from and/or writes to a removable storage unit 1018 in a manner well known to those having ordinary skill in the art.

Removable storage unit 1018, represents a floppy disk, a compact disc, magnetic tape, optical disk, etc. which is read by and written to by removable storage drive 1016. As are appreciated, the removable storage unit 1018 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 1012 may include other similar means for allowing computer programs or other instructions to be loaded into the computing system 1000. Such means may include, for example, a removable storage unit 1022 and an interface 1020. Examples of such may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to the computing system 1000.

The computing system 1000, in this example, includes a communications interface 1024 that acts as an input and output and allows software and data to be transferred between the computing system 1000 and external devices or access points via a communications path 1026. Examples of communications interface 1024 may include a modem, a network interface (such as an Ethernet card), a communications port, a PCMCIA slot and card, etc. Software and data transferred via communications interface 10210 are in the form of signals which may be, for example, electronic, electromagnetic, optical, or other signals capable of being received by communications interface 1024. The signals are provided to communications interface 1024 via a communications path (i.e., channel) 1026. The channel 1026 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 1006 and secondary memory 1012, removable storage drive 1016, and a hard disk installed in hard disk drive 1014. The computer program products are means for providing software to the computer system. The computer readable medium allows the computer system to read data, instructions, messages or message packets, and other computer readable information from the computer readable medium.

Computer programs (also called computer control logic) are stored in main memory 1006 and/or secondary memory 1012. Computer programs may also be received via communications interface 1024. Such computer programs, when executed, enable the computer system to perform the features of the various embodiments of the present invention as discussed herein. In particular, the computer programs, when executed, enable the processor 1004 to perform the features of the computer system.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method, with a frame structure comprising a first portion and a second portion configured to receive an entity to be examined therebetween, for detecting radiation and identifying materials associated with radiation that has been detected, the method comprising:
determining that an entity to be examined has entered between a first portion and at least a second portion of the frame structure;
receiving from a set of radiation sensors mechanically coupled to the at least one portion of the frame structure, a set of radiation data associated with the entity, wherein the set of radiation sensors includes a plurality of radiation sensors situated in a horizontal configuration with respect to each other and a direction of travel through the frame structure associated with the entity currently being examined;
generating at least one histogram based on the set of radiation data, wherein the at least one histogram represents a spectral image of the entity;
comparing the at least one histogram to a plurality of spectral images associated with known materials;
determining that the at least one histogram substantially match at least one of the plurality of spectral images;
determining if a material associated with the at least one of the plurality of spectral images is a hazardous material; and
notifying personnel that the at least one radiation source is a hazardous material in response to determining that the material associated with the at least one of the plurality of spectral images is a hazardous material.

2. The method of claim 1, wherein the set of radiation data is received while the entity is moving through the frame structure.

3. The method of claim 1, wherein the set of radiation data is received while the entity is stationary with respect to the frame structure.

4. The method of claim 1, wherein the set of radiation data includes at least gamma radiation information.

5. The method of claim 1, wherein the known materials are isotopes.

6. The method of claim 1, further comprising;
determining that the material associated with the at least one of the plurality of spectral images fails to be a hazardous material;
comparing the material with at least one manifest associated with an entity comprising the radiation source;
determining if the material substantially matches at least one item on the at least one manifest; and
notifying personnel that the entity comprises at least one unauthorized item in response to determining that the material fails to substantially match at least one item on the at least one manifest.

7. A frame structure for detecting radiation and identifying materials associated with radiation that has been detected, the frame structure comprising:
at least one side portion;
at least one set of radiation sensors mechanically coupled to the at least one side portion including a plurality of radiation sensors situated in a horizontal configuration with respect to each other and a direction of travel provided through the frame structure to an entity being examined; and
a communication mechanism communicatively coupled to the at least one set of radiation sensors, wherein the communication mechanism transmits a set of radiation data associated with the entity that has been detected by the set of radiation detectors to at least one information processing system.

8. The frame structure of claim 7, further comprising:
at least one additional side portion situated opposite from the at least one side portion;
a passage between the at least one side portion and the at least one additional side portion configured to allow the entity to pass between the at least one side portion and the at least one additional side portion; and
at least one additional set of radiation sensors mechanically coupled to the at least one additional side portion including a plurality of radiation sensors situated in a horizontal configuration with respect to each other and the direction of travel provided through the frame structure to an entity being examined.

9. The frame structure of claim 7, further comprising:
at least one additional portion situated one of above and below the at least one side portion.

10. The frame structure of claim 9, wherein the at least one additional portion includes a set of radiation sensors mechanically coupled to the at least one additional portion including a plurality of radiation sensors situated in a horizontal configuration with respect to each other and a direction of travel provided through the frame structure to an entity being examined.

11. The frame structure of claim 7, wherein the set of radiation data includes at least gamma radiation information.

12. The frame structure of claim 7, further comprising:
at least one information processing system communicatively coupled to the at least one set of radiation sensors, wherein the at least one information processing system is adapted to:
determine that an entity to be examined has entered between a first portion and at least a second portion of the frame structure;
receive from at least one set of radiation sensors mechanically coupled to the at least one portion of the frame structure the set of radiation data associated with the entity, wherein the set of radiation sensors includes a plurality of radiation sensors situated in a horizontal configuration with respect to each other and a direction of travel through the frame structure associated with the entity currently being examined;
generate at least one histogram based on the set of radiation data, wherein the at least one histogram represents a spectral image associated with the entity;
compare the at least one histogram to a plurality of spectral images associated with known materials;
determine that the at least one histogram substantially matches at least one of the plurality of spectral images;
determine if a material associated with the at least one of the plurality of spectral images is a hazardous material; and
notify personnel that the at least one radiation source is a hazardous material in response to determining that the material associated with the at least one of the plurality of spectral images is a hazardous material.

13. The frame structure of claim 12, wherein the at least one information processing system is further adapted to;
determine that the material associated with the at least one of the plurality of spectral images fails to be a hazardous material;
compare the material with at least one manifest associated with an entity comprising the radiation source;
determine if the material substantially matches at least one item on the at least one manifest; and
notify personnel that the entity comprises at least one unauthorized item in response to determining that the material fails to substantially match at least one item on the at least one manifest.

14. A system for detecting radiation and identifying materials associated with radiation that has been detected, the system comprising:
a frame structure comprising:
at least one side portion;
at least one set of radiation sensors mechanically coupled to the at least one side portion including a plurality of radiation sensors situated in a horizontal configuration with respect to each other and a direction of travel provided through the frame structure to an entity being examined; and
a communication mechanism communicatively coupled to the at least one set of radiation sensors, wherein the communication mechanism transmits a set of radiation data associated with the entity that has been detected by the set of radiation sensors to at least one information processing system; and
at least one information processing system communicatively coupled to the at least one set of radiation sensors.

15. The system of claim 14, wherein the frame structure further comprises:
at least one additional side portion situated opposite from the at least one side portion;
a passage between the at least one side portion and the at least one additional side portion configured to allow the entity to pass between the at least one side portion and the at least one additional side portion; and
at least one additional set of radiation sensors mechanically coupled to the at least one additional side portion including a plurality of radiation sensors situated in a horizontal configuration with respect to each other and the direction of travel provided through the frame structure to an entity being examined.

16. The system of claim 14, wherein the frame structure further comprises:
at least one additional portion situated one of above and below the at least one side portion.

17. The system of claim 16, wherein the at least one additional portion includes a set of radiation sensors mechanically coupled to the at least one additional portion including a plurality of radiation sensors situated in a horizontal configuration with respect to each other and a direction of travel provided through the frame structure to an entity being examined.

18. The system of claim 14, wherein the set of radiation data includes at least gamma radiation information.

19. The system of claim 14, wherein the at least one information processing system is adapted to:
determine that an entity to be examined has entered between a first portion and at least a second portion of the frame structure;
receive from a set of radiation sensors mechanically coupled to the at least one portion of the frame structure, a set of radiation data associated with the entity, wherein the set of radiation sensors includes a plurality of radiation sensors situated in a horizontal configuration with respect to each other and a direction of travel through the frame structure associated with the entity currently being examined;
generate at least one histogram based on the set of radiation data, wherein the at least one histogram represents a spectral image associated with the entity;
compare the at least one histogram to a plurality of spectral images associated with known materials;
determine that the at least one histogram substantially match at least one of the plurality of spectral images;
determine if a material associated with the at least one of the plurality of spectral images is a hazardous material; and
notify personnel that the at least one radiation source is a hazardous material in response to determining that the material associated with the at least one of the plurality of spectral images is a hazardous material.

20. The system of claim 19, wherein the at least one information processing system is further adapted to:
determine that the material associated with the at least one of the plurality of spectral images fails to be a hazardous material;
compare the material with at least one manifest associated with an entity comprising the radiation source;
determine if the material substantially matches at least one item on the at least one manifest; and
notify personnel that the entity comprises at least one unauthorized item in response to determining that the material fails to substantially match at least one item on the at least one manifest.
